(19) United States
(12) Patent Application Publication
(10) Pub. No.: US 2007/0081083 A1
(43) Pub. Date: Apr. 12, 2007

(54) Oscillator circuit and infrared receiver

(75) Inventor: Takahiro Inoue, Katsuragi-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/545,580

(22) Filed: Oct. 11, 2006

(30) Foreign Application Priority Data
Oct. 12, 2005 (JP) 2005-298108

(51) Int. Cl. H04N 5/228

(52) U.S. Cl. 348/222.1

(57) ABSTRACT

An oscillator circuit includes: a charge and discharge circuit for charging or discharging a capacitor; and a signal generating circuit for generating a signal in which (i) an interval time period indicative of a cycle on which cycle a receiving device performs a periodical intermittent operation and (ii) a watch time period indicative of a time period during which the receiving device performing the periodical intermittent operation is in an ON state are set based on a charge and discharge signal which varies according to charging and discharging of the charge and discharge circuit with respect to the capacitor. Further, the signal generating circuit sets in the signal (i) the interval time period based on a difference between first and second voltages and (ii) the watch time period based on a difference between third and fourth voltages. The third and fourth voltages fall in a range between the first and second voltages. With the interval time period and the watch time period thus set in the signal, the periodical intermittent operation of the receiving device is realized.

This Nonprovisional application claims priority under 35 U.S.C. § 119(a) on Patent Application No. 298108/2005 filed in Japan on Oct. 12, 2005, the entire contents of which are hereby incorporated by reference.

### FIELD OF THE INVENTION

The present invention relates to an infrared receiver and an oscillator circuit including: a charge and discharge circuit for charging or discharging a capacitor; and a signal generating circuit which generates a signal for driving a receiving device to perform a periodical intermittent operation based on a charge and discharge signal which varies according to charging and discharging of the charge and discharge circuit with respect to the capacitor.

### BACKGROUND OF THE INVENTION

There has been a strong demand for battery-driven devices to have a reduced consumption current in a standby mode. Commonly, such devices realize a reduction in consumption current in a standby mode by using an oscillator circuit that causes a device to perform a periodical intermittent operation. Here, assume that (i) a cycle during which a device performs a periodical intermittent operation is an interval time period and (ii) a time period during which the device is in an ON state is a watch time period. In this case, if the ratio of time constant, i.e., the ratio between the interval time period and the watch time period, is set large, the device can have a reduced consumption current in a standby mode. Since the oscillator circuit constantly operates while the device performs the periodical intermittent operation, configuring an oscillator circuit to have a low consumption current is critical for the device to reduce a consumption current in a standby mode.

One such oscillator circuit has been known which generates an output signal based on a charge and discharge signal which varies according to charging or discharging with respect to a capacitor (e.g. see Japanese Unexamined Patent Publication No. 237609/1988 (see Tokukaisho 63-237609, publication date: Oct. 4, 1998) (Patent Document 1).

FIG. 14 is a block diagram illustrating substantial parts of a conventional infrared receiver 91. The infrared receiver 91 includes a receiving device 93 for receiving an input signal via infrared communication, and an oscillator circuit 92 for generating an output signal out90, used to drive the receiving device 93 to perform a periodical intermittent operation.

FIG. 15 is a circuit diagram illustrating a circuitry of an oscillator circuit 92, and FIG. 16 is a waveform chart representing its operations. The oscillator circuit 92 includes a charge and discharge circuit 94 for charging or discharging a capacitor 90. The charge and discharge circuit 94 includes transistors (simply “Tr” hereinafter) 91 and 92, whose sources and gates are respectively connected to each other. The gate and a drain of the Tr91 are connected to each other. The drain of the Tr91 is connected to a current source I91, and a drain of the Tr92 is connected to the capacitor 90.

The charge and discharge circuit 94 further includes Tr93 and Tr94, whose gates and drains are respectively connected to each other. The gate and a source of the Tr93 are connected to each other. The source of the Tr93 is connected to a current source I92, and a source of Tr94 is connected to the capacitor 90. The charge and discharge circuit 94 further includes a Tr95, whose source and drain are connected to the drain and the source of Tr93, respectively. The source of the TR95 is connected to the capacitor 90.

The oscillator circuit 92 further includes a comparator circuit 96. The comparator circuit 96 includes a comparator 97a and a comparator 97b. The comparator 97a compares (i) a charge and discharge signal X derived from a charge and discharge voltage for charging or discharging a capacitor CO and (ii) a reference voltage Vth1, and the comparator 97b compares (ii) the charge and discharge signal X and (ii) a reference voltage Vth2.

The oscillator circuit 92 further includes a logic circuit 95. The logic circuit 95 includes exclusive-OR gates (hereinafter referred to as NAND elements) 91a and 91b. One input terminal of the NAND element 91a receives, through two inverters, a signal S indicating a result of comparison made by the comparator 97a. Another input terminal of the NAND element 91a is connected to an output terminal of the NAND element 91b. One input terminal of the NAND element 91b receives, through an inverter, a signal R indicating a result of comparison made by the comparator 97b. Another input terminal of the NAND element 91b is connected to an output terminal of the NAND element 91a.

The output terminal of the NAND element 91a is connected to (i) the another input terminal of the NAND element 91b and (ii) a gate of Tr95 of the charge and discharge circuit 94. From the output terminal of the NAND element 91b, an output signal out90 is outputted through two inverters.

When the capacitor 90 is charged by the current source I91, and the charge and discharge signal X rises from the level of the reference voltage Vth1. Then, when the charge and discharge signal X reaches the level of the reference voltage Vth2, an output signal of the comparator 97b is inverted from low to high, and accordingly the signal R is inverted from high to low. This causes an output signal -Q of the NAND element 91b to be inverted from low to high and an output signal Q of the NAND element 91a (i.e., output signal out90) to be inverted from high to low. As a result, the Tr95 of the charge and discharge circuit 94 is turned OFF, and the current source I92 starts charging the capacitor 90. Since the current source I91 constantly charges the capacitor CO, the capacitor 90 discharges a current expressed by ((current of the current source I92)−(current of the current source I91)) when (current of the current source I92)>(current of the current source I91) is set. This causes the charge and discharge signal X to start decreasing from the level of the reference voltage Vth2, and the signal R to be inverted from low to high.

When the charge and discharge signal X decreases and reaches the level of the reference voltage Vth1, an output signal of the comparator 97a and the signal S are inverted from high to low, and the signal Q of the NAND element 91a is inverted from low to high. This causes the Tr95 to turn ON and the current source I92 to stop discharging the capacitor 90. The capacitor 90 is then charged again by the current source I91, with the result that the charge and discharge signal X rises again from the level of the reference voltage Vth1 to the level of reference voltage Vth2.

A time period during which the capacitor 90 is charged and the charge and discharge signal X increases from the level of the reference voltage Vth1 to the level of the reference voltage Vth2 corresponds to a time period t1 during which the signal Q is in a high state. On the other hand, a period during which the capacitor 90 is discharged and the charge and discharge signal X decreases from the level of the reference voltage Vth2 to the level of the reference voltage Vth1 corresponds to a time period t2 during which the signal Q is in a low state. The time periods t1 and t2 are expressed by the following equations:
t1=C90×(Vth2−Vth1)/I91
t2=C90×(Vth2−Vth1)/(I92−I91),
where an interval time period t_int and a watch time period t_watch are found by the following equations (1) and (2).

$$\begin{matrix}\begin{matrix}t\_int = t 1 + t 2 \\ = C 90 \times ( Vth 2 - Vth 1 ) / ( I 91 / I 92 \times ( I 92 - I 91 ) )\end{matrix} & ( 1 ) \\ \begin{matrix}t\_watch = t 2 \\ = C 90 \times ( Vth 2 - Vth 1 ) / ( I 92 - I 91 )\end{matrix} & ( 2 )\end{matrix}$$

Thus, the ratio of time constant, i.e., the ratio between the interval time period t_int and the watch time period t_watch, is expressed by the following equation (3).
t_int/t_watch=I92/I91 (3)

When the receiving device 93 is driven by the oscillator circuit 92 to perform a periodical intermittent operation, a consumption current of the receiving device 93 during the periodical intermittent operation can be reduced by setting the ratio of the time constant large, i.e., by setting a large value for the ratio between the watch time period t_watch and the interval time period t_int.

In the conventional arrangement, however, it is difficult to set a large value for the ratio of time constant, the ratio between the interval time period t_int and the watch time period t_watch. In this regard, the following describes in more detail.

Since the receiving device is in an ON state during the watch time period, the consumption current becomes a total consumption current Itotal. On the contrary, during time periods other than the watch time period, the receiving device is in an OFF state. Thus, the consumption current becomes a consumption current Isd, which is obtained in the OFF state of the receiving device. The consumption current Isd corresponds to a consumption current of the oscillator circuit 92. Here, an average consumption current during 1 cycle of the periodical intermittent operation is found by the following equation (4).
Isd+Itotal×(t_watch/t_int) (4)

In order to have a reduced consumption current during the periodical intermittent operation, (t_watch/t_int) needs to be a small value. In other words, the ratio of time constant, i.e., the inverse number of (t_watch/t_int), needs to be set large. That is, it is necessary to set the ratio of a current of I92 to a current of I91 large based on the equation (3). Table 1 below shows examples of set values required to satisfy the following conditions: t_int=1 sec (=1000 msec) and t_watch=1 msec (i.e., I91:I92=1:1000).

TABLE 1

| T_int | T_watch | C | | Vth2 − Vth1 | I91 | | I92 | |
|---|---|---|---|---|---|---|---|---|
| 1 sec | 1 msec | 0.1 | uF | 1 V | 100 | nA | 100 | uA |
| | | 0.01 | uF | | 10 | nA | 10 | uA |
| | | 0.001 | uF | | 1 | nA | 1 | uA |

As shown in Table 1, when I92 is set to 100 nA, I92 needs to be 100 μA. Setting such a large value for I92 gives rise to a problem of increasing the consumption current Isd of the oscillator circuit 92, i.e., the consumption power of the oscillator circuit 92.

When I92 is set small, I91 needs to be set small accordingly. For example, when I92 is set to 1 μA, I91 needs to be 1 nA. Setting I91 to such a minute current value of several nano ampere orders, the operation of the charge and discharge circuit 92 becomes unstable being affected by leak current.

### SUMMARY OF THE INVENTION

The present invention is made in view of the foregoing problems, and an object of the invention is to realize an infrared receiver and an oscillator circuit having a large value for the ratio of time constant, i.e., the ratio between the interval time period t_int and the watch time period t_watch, so as to reduce a consumption current during a periodical intermittent operation.

According to the present invention, to attain the foregoing object, there is provided an oscillator circuit including: a charge and discharge circuit for charging or discharging a capacitor; and a signal generating circuit for generating a signal in which (i) an interval time period indicative of a cycle on which cycle a receiving device performs a periodical intermittent operation and (ii) a watch time period indicative of a time period during which the receiving device performing the periodical intermittent operation is in an ON state are set based on a charge and discharge signal which varies according to charging and discharging of the charge and discharge circuit with respect to the capacitor, the signal generating circuit setting in the signal (i) the interval time period based on a difference between first and second voltages and (ii) the watch time period based on a difference between third and fourth voltages, the third and fourth voltages falling in a range between the first and second voltages.

With the above feature, the ratio of time constant, i.e., the ratio between the watch time period and the interval time period, can be set based on (i) a difference between the first and second voltages, and (ii) a difference between the third and fourth voltages, as well as based on the ratio of currents at current sources provided in the charge and discharge circuit. Thus, the ratio of the time constant is not necessarily set only based on the ratio of currents at current sources provided in the charge and discharge circuit as in a conventional structure. This prevents such problems that one of the current sources provided in the charge and discharge circuit has an extremely large current and thus the oscillator circuit has an extremely large consumption current, and that another one of the current sources has a small current of about several μA and thus operation of the circuit becomes unstable being affected by leak current. This enables setting a large value for the ratio of time constant, i.e., the ratio between the interval time period and the watch time period large. Thus, an oscillator circuit is realized which is capable of having a reduced consumption current during a periodical intermittent operation.

According to the present invention, to attain the foregoing object, there is provided an infrared receiver including: an oscillator circuit according to the present invention; and a receiving device which performs the periodical intermittent operation based on the signal generated by the oscillator circuit.

With the above feature, it is possible for the receiving device to have a reduced consumption current during a standby mode, by setting a large value for the ratio of time constant, i.e., the ratio between the watch time period and the interval time period both set in the signal generated by the oscillator circuit.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a circuit diagram illustrating substantial parts of an oscillator circuit according to a first embodiment.

FIG. 2 is a block diagram illustrating a structure of an infrared receiver including the oscillator circuit.

FIG. 3 is a circuit diagram illustrating a circuitry of a comparator circuit provided in the oscillator circuit.

FIG. 4 is a schematic view illustrating a layout of transistors in an input stage of the comparator circuit.

FIG. 5 is a view illustrating an arrangement of resistors for generating reference voltages of the comparator circuit provided in the oscillator circuit.

FIG. 6 is a waveform chart representing operations of the oscillator circuit.

FIG. 7 is a circuit diagram illustrating substantial parts of an oscillator circuit according to a second embodiment.

FIG. 8 is a waveform chart representing operations of the oscillator circuit.

FIG. 9 is a circuit diagram illustrating substantial parts of an oscillator circuit according to a third embodiment.

FIG. 10(a) is a circuit diagram illustrating a circuitry of an initial setting circuit provided in the oscillator circuit, and FIG. 10(b) is a waveform chart representing its operations.

FIG. 11 is a waveform chart representing operations of the oscillator circuit.

FIG. 12 is a circuit diagram illustrating substantial parts of an oscillator circuit according to a fourth embodiment.

FIG. 13 is a waveform chart representing operations of the oscillator circuit.

FIG. 14 is a block diagram illustrating substantial parts of a conventional infrared receiver.

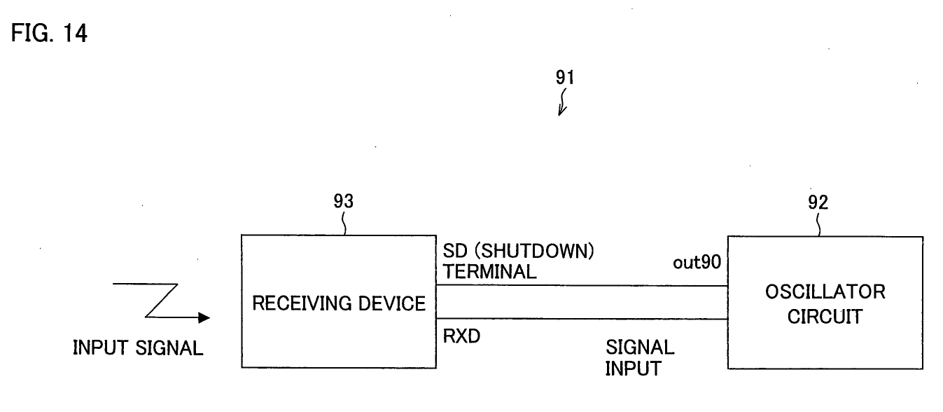

FIG. 15 is a circuit diagram illustrating a circuitry of an oscillator circuit provided in the infrared receiver.

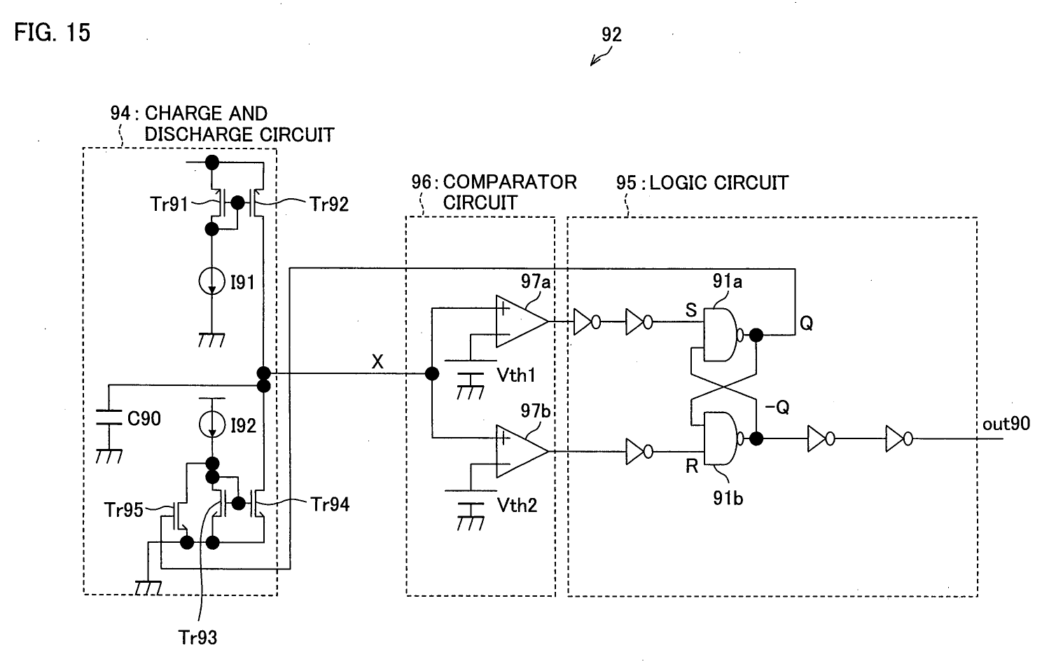

FIG. 16 is a waveform chart representing operations of the oscillator circuit.

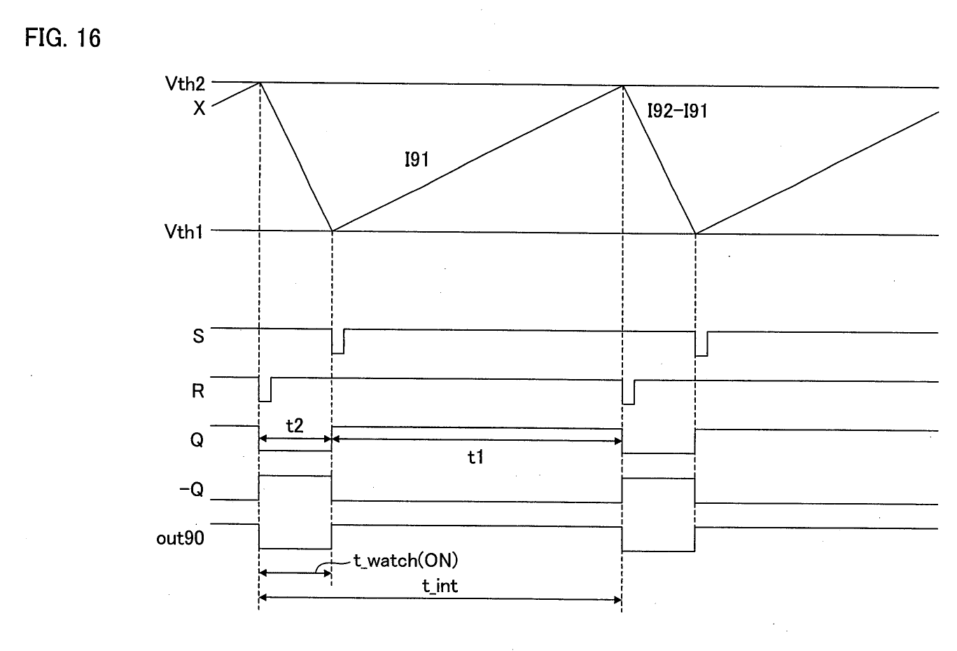

### DESCRIPTION OF THE EMBODIMENTS

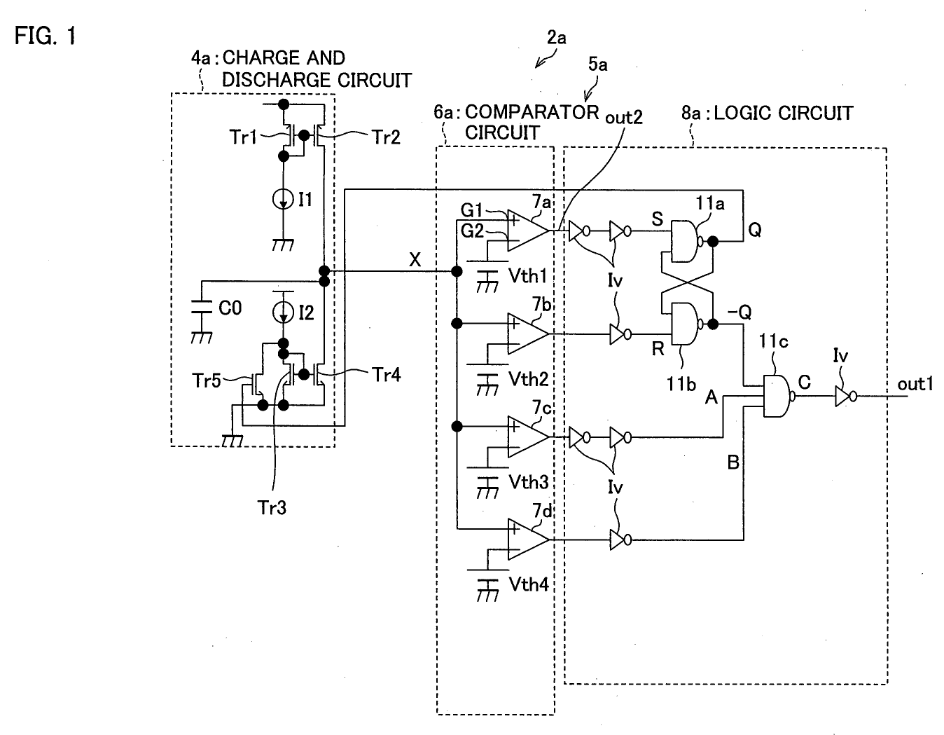

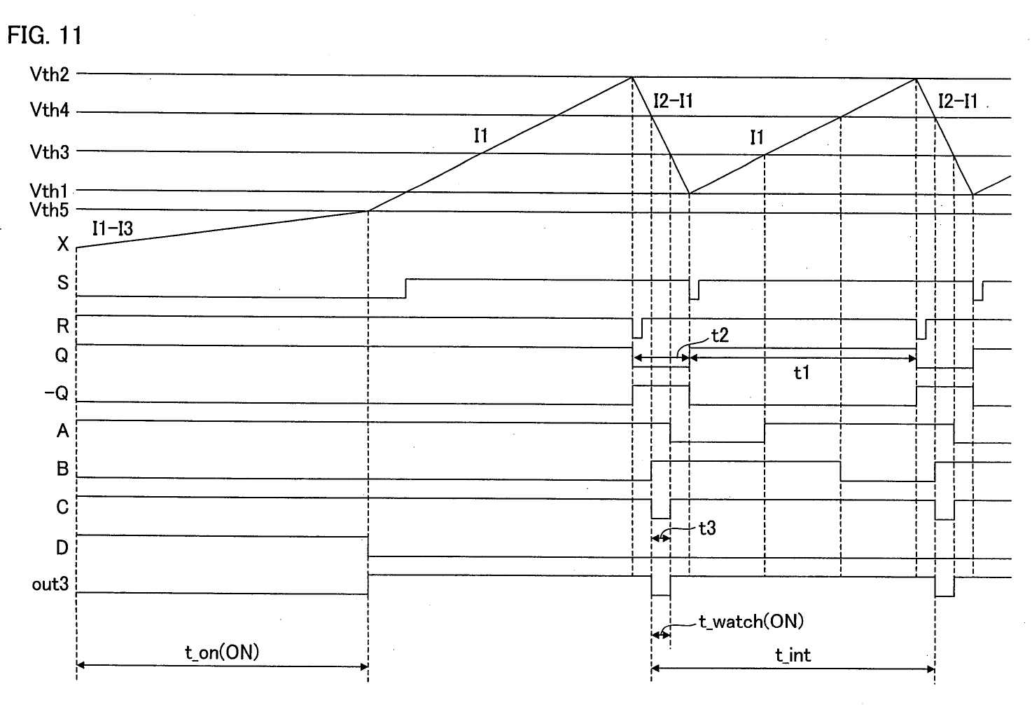

Referring to FIGS. 1 through 13, the following describes embodiments of the present invention.

[First Embodiment]

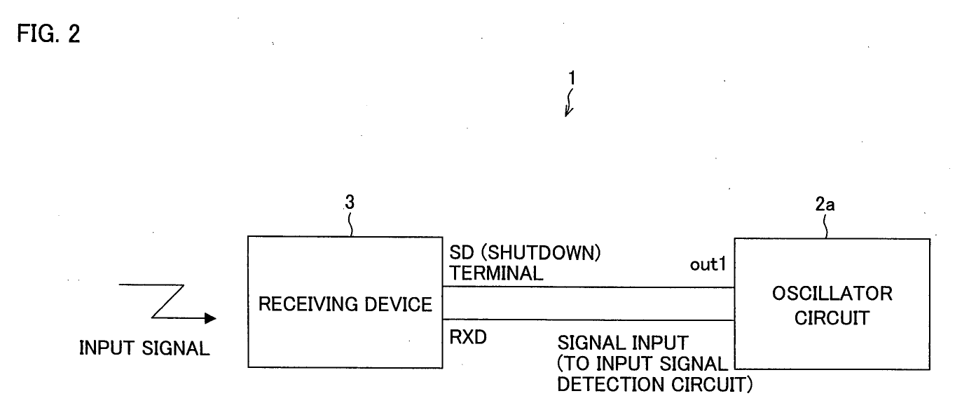

FIG. 1 is a circuit diagram illustrating substantial parts of an oscillator circuit 2a according to a first embodiment. FIG. 2 is a block diagram illustrating a structure of an infrared receiver 1 including the oscillator circuit 2a. The infrared receiver 1 includes a receiving device 3 which receives an input signal via infrared communication, and the oscillator circuit 2a which generates an output signal out1 for driving the receiving device 3 to perform a periodical intermittent operation.

The oscillator circuit 2a includes a charge and discharge circuit 4a for charging or discharging a capacitor CO. The charge and discharge circuit 4aincludes PMOS Tr1 and Tr2, whose sources and gates are respectively connected to each other. The gate and a drain of the PMOS Tr1 are connected to each other. The drain of the PMOS transistor Tr1 is connected to a current source I1, and a drain of the PMOS Tr2 is connected to the capacitor CO.

The charge and discharge circuit 4a further includes NMOS Tr3 and Tr4, whose gates and drains are connected to each other. The gate and a source of the NMOS Tr3 are connected to each other. The source of the NMOS Tr3 is connected to a current source I2, and a source of the NMOS Tr4 is respectively connected to the capacitor CO. The charge and discharge circuit 4a further includes an NMOS Tr5, whose source and drain are connected to the source and the drain of the NMOS Tr3, respectively.

The oscillator circuit 2a further includes a comparator circuit 6a. The comparator circuit 6a includes comparators 7a through 7d. The comparator 7a compares (i) a charge and discharge signal X derived from a charge and discharge voltage for charging or discharging the capacitor CO and (ii) a reference voltage Vth1. The comparator 7b compares the charge and discharge signal X and a reference voltage 2, the comparator 7c compares the charge and discharge signal X and a reference voltage Vth3, and the comparator 7d compares the charge and discharge signal X and a reference voltage Vth4.

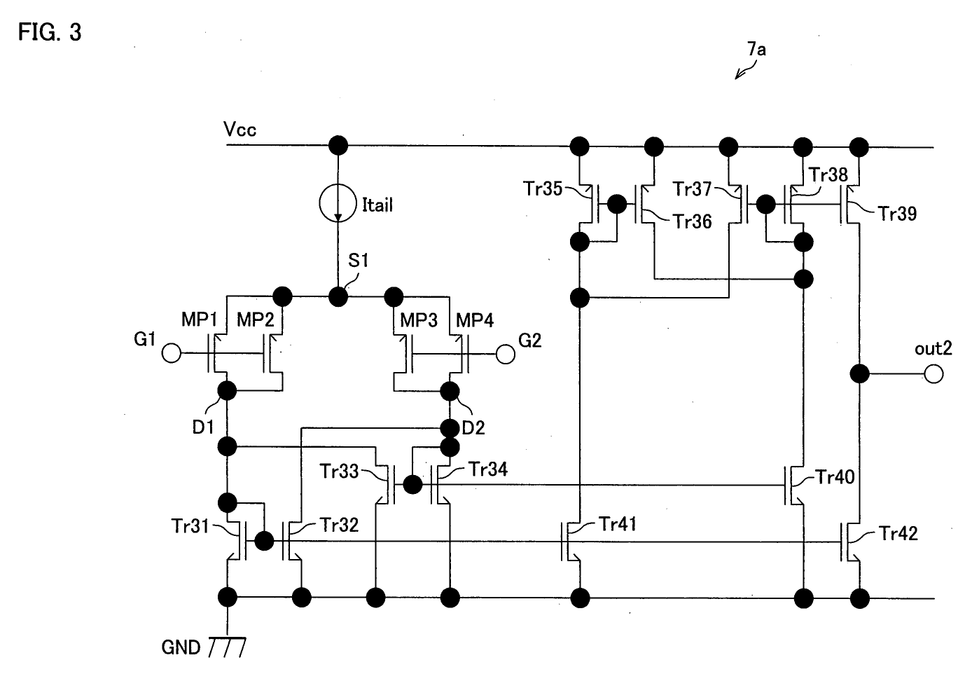

FIG. 3 is a circuit diagram illustrating a circuitry of the comparator 7a. Since the comparators 7a through 7d are configured in the same manner, the following describes the circuitry of the comparator 7a by way of example.

The comparator 7a includes PMOS transistors MP1 and MP2. Gates of the PMOS transistors MP1 and MP2 are connected to each other, and receive the charge and discharge signal X supplied via a non-inverting input terminal G1 of the comparator 7a. Sources of the PMOS transistors MP1 and MP2 are connected to one end of a current source Itail through a terminal S1. Another end of the current source Itail is connected to a line through which a power supply voltage Vcc is supplied. Drains of the PMOS transistors MP1 and MP2 are connected to a terminal D1.

The comparator 7a further includes PMOS transistors MP3 and MP4. Gates of the PMOS transistors MP3 and PM4 are connected to each other, and receive the reference voltage Vth2 supplied via an inverting input terminal G2. Sources of the PMOS transistors MP3 and MP4 are connected to the one end of the current source Itail through the terminal S1. Drains of the PMOS transistors MP3 and MP4 are connected to a terminal D2.

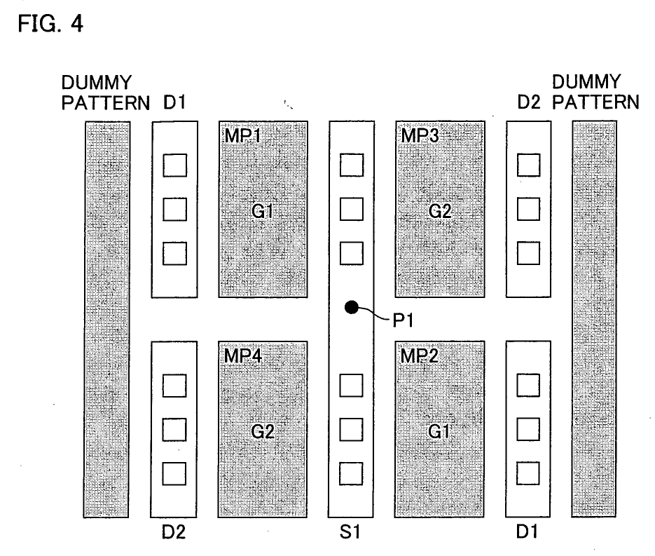

The PMOS transistors MP1, MP2, MP3, and MP4, provided in an input stage of the comparator 7a, are arranged in a common-centroid layout, as shown in FIG. 4. As used herein, the common-centroid layout refers to a layout in which the MOS transistors provided in the input stage are symmetric with respect to a point. With the terminal S1 having a bar shape provided in between, the PMOS transistors MP1 and MP3 are arranged so as to face each other, and the PMOS transistors MP4 and MP2 are arranged so as to face each other. A center of gravity of the PMOS transistors MP1 and MP2 and a center of gravity of the PMOS transistors MP3 and MP4 match on the center of the terminal S1, i.e., point P1. That is, the MOS transistors MP1, MP2, MP3, and MP4 are provided so as to be symmetric with respect to the point P1. Terminals D1 are respectively provided across the PMOS transistor MP1 from the terminal S1, and across the PMOS transistor MP2 from the terminal S1. Terminals D2 are respectively provided across the PMOS transistor MP3 from the terminal S1, and across the PMOS transistor MP4 from the terminal S1. On outer sides of the terminals D1 and D2, dummy patterns are formed, respectively.

The comparator 7a further includes NMOS Tr31, Tr32, Tr41, and Tr42, whose gates are connected to each other. The gate and a source of the NMOS Tr31 are connected to each other. The source of the NMOS Tr31 is connected to the terminal D1, and a source of the NMOS Tr32 is connected to the terminal D2.

The comparator 7a further includes NMOS Tr33, Tr34, and Tr40. A source of the NMOS Tr33 is connected to the terminal D1, and a gate and a source of the NMOS Tr34 are connected to each other. The sources of the NMOS Tr34 and Tr32 are connected to the terminal D2.

The comparator 7a further includes PMOS Tr35 and Tr36, whose gates are connected to each other, and whose sources are connected to the line through which the power supply voltage Vcc is supplied. The gate and a drain of the PMOS Tr35 are connected to each other, and the drain of the PMOS Tr35 is connected to a source of the NMOS Tr41. Further, a drain of the PMOS Tr36 is connected to a source of the NMOS Tr40.

The comparator 7a further includes PMOS Tr37, Tr38, and Tr39, whose gates are connected to each other, and whose sources are connected to the line through which the power supply voltage Vcc is supplied. A drain of the PMOS Tr37 is connected to the source of the NMOS Tr41. The gate and a drain of the PMOS Tr38 are connected to each other, and the drain of the PMOS Tr38 is connected to the source of the NMOS Tr40. Further, a drain of the PMOS Tr39 is connected to a source of the NMOS Tr42 and to an output terminal of the comparator 7a via which an output signal out2 is outputted.

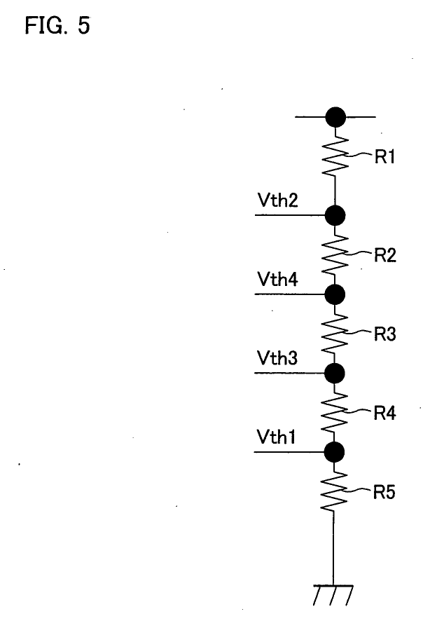

FIG. 5 is a view illustrating an arrangement of resistors R1, R2, R3, R4, and R5 for generating the reference voltages Vth1, Vth2, Vth3, and Vth4 of the comparator circuit 6a. The resistors R1, R2, R3, R4, and R5 are connected in series. Opposite the resistor R2, one end of the resistor R1 is connected to a line through which a certain voltage is supplied. Opposite the resistor R4, one end of the resistor R5 is connected to ground. The reference voltage Vth1 is supplied to the inverting input terminal G2 of the comparator 7a via a terminal provided between the resistors R4 and R5. The reference voltage Vth2 is supplied to an inverting input terminal of the comparator 7b via a terminal provided between the resistors R1 and R2. The reference voltage Vth3 is supplied to an inverting input terminal of the comparator 7c via a terminal provided between the resistors R3 and R4. Further, the reference voltage Vth4 is supplied to an inverting input terminal of the comparator 7d via a terminal provided between the resistors R2 and R3.

The oscillator circuit 2a includes a logic circuit 5a. The logic circuit 5a includes NAND elements 11a, 11b, and 11c. One input terminal of the NAND element 11a receives, through two inverters Iv, the output signal out2 indicating a result of comparison made by the comparator 7a. Another input terminal of the NAND element 11a is connected to an output terminal of the NAND element 11b. One input terminal of the NAND element 11b receives, through an inverter Iv, a signal R indicating a result of comparison made by the comparator 7b. Another input terminal of the NAND element 11b is connected to an output terminal of the NAND element 11a. The NAND elements 11a and 11b are configured as SR latch circuits.

The output terminal of the NAND element 11a is connected to a gate of the NMOS Tr5 of the charge and discharge circuit 4a. The output terminal of the NAND element 11b is connected to an input terminal of the NAND element 11c. Another input terminal of the NAND element 11c receives, through two inverters Iv, a signal A indicating a result of comparison made by the comparator 7c. Further another input terminal of the NAND element 11c receives, through an inverter Iv, a signal B indicating a result of comparison made by the comparator 7d. The NAND element 11c outputs a signal C, which is inverted through an inverter Iv and outputted from the oscillator circuit 2a as an output signal out1.

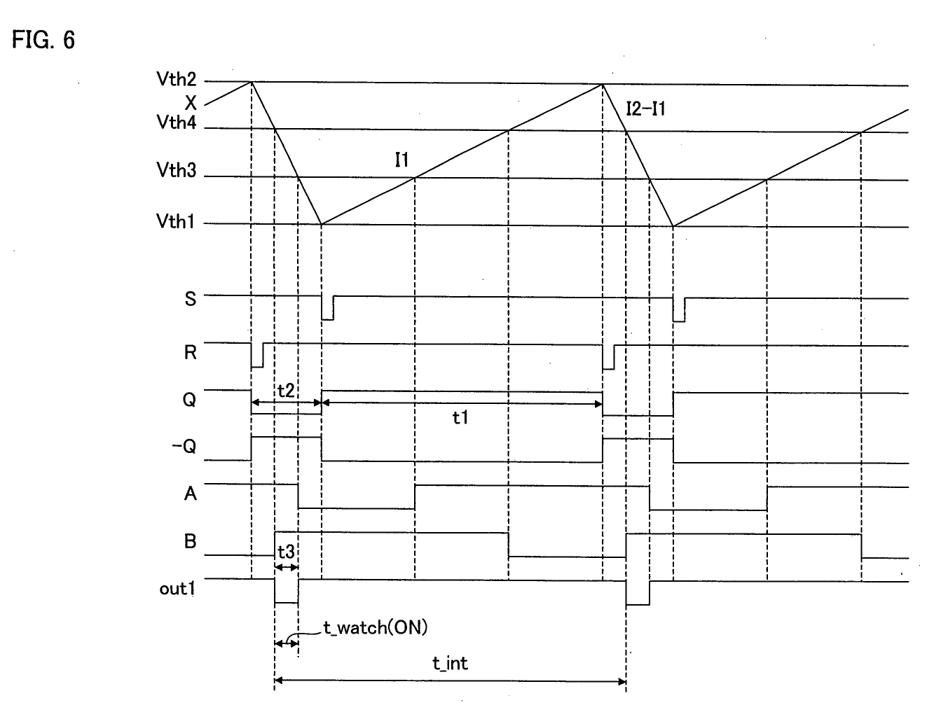

FIG. 6 is a waveform chart representing operations of the oscillator circuit 2a. When the capacitor CO is charged by the current source I1, the charge and discharge signal X rises from the level of the reference voltage Vth1. Then, when the charge and discharge signal X reaches the level of the reference voltage Vth3, an output signal of the comparator 7c is inverted from low to high, and accordingly the signal A is inverted from low to high. When the charge and discharge signal X further increases from the level of the reference voltage Vth3 and reaches the level of the reference voltage Vth4, an output signal of the comparator 7d is inverted from low to high, and accordingly a signal B is inverted from high to low. When the charge and discharge-signal X further increases from the level of the reference voltage Vth4 and reaches the level of the reference voltage Vth2, an output signal of the comparator 7b is inverted from low to high, and accordingly the signal R is inverted from high to low. This causes an output signal -Q of the NAND element 11b to be inverted from low to high, and an output signal Q of the NAND element 11a to be inverted from high to low. As a result, the NMOS Tr5 of the charge and discharge circuit 4a is turned OFF, and the current source I2 starts discharging the capacitor CO. Since the current source I1 constantly charges the capacitor CO, the capacitor CO is discharged by a current expressed by ((current of the current source I2)−(current of the current source I1)) when (current of the current source I2)>(current of the current source I1) is set. This causes the charge and discharge signal X to start decreasing from the level of the reference voltage Vth2, and the signal R to be inverted from low to high.

When the charge and discharge signal X decreases from the level of the reference voltage Vth2 and reaches the level of the reference voltage Vth4, an output signal of the comparator 7d is inverted from high to low, and accordingly the signal B is inverted from low to high. This causes all the signals -Q, A, and B to be supplied to the NAND element 11c in a high state. As a result, the signal C outputted from the NAND element 11c is inverted from low to high, causing the output signal out1 of the logic circuit 8a to be inverted from high to low.

When the charge and discharge signal X decreases from the level of the reference voltage Vth4 and reaches the level of the reference voltage Vth3, an output signal of the comparator 7c is inverted from high to low, and accordingly the signal A is inverted from high to low. Since one of the signals -Q, A, and B, i.e., signal A, is inverted from high to low, the signal C outputted from the NAND element 11c is inverted again from high to low, with the result that the output signal out1 is inverted again from low to high.

When the charge and discharge signal X decreases from the level of the reference voltage Vth3 and reaches the level of the reference voltage Vth1, the signal out2 of the comparator 7a is inverted from high to low and the signal S is inverted from high to low, causing the signal Q outputted from the NAND element 11a to be inverted from low to high. As a result, the Tr5 is turned ON, and the current source I2 stops discharging the capacitor CO. The capacitor CO is then charged again by the current source I1, and the charge and discharge signal X rises again from the level of the reference voltage Vth1 toward the level of reference voltage Vth3.

A period during which the capacitor CO is charged and the charge and discharge signal X increases from the level of the reference voltage Vth1 to the level of the reference voltage Vth2 corresponds to a time period t1 during which the signal Q is in a high state. On the other hand, a period during which the capacitor CO is discharged and the charge and discharge signal X decreases from the level of the reference voltage Vth2 to the level of the reference voltage Vth1 corresponds to a time period t2 during which the signal Q is in a low state. The time periods t1 and t2 are expressed by the following equations:
t1=CO×(Vth2−Vth1)/I1
t2=CO×(Vth2−Vth1)/(I2−I1)

In the present embodiment, the watch time period is set based on a difference between the reference voltages Vth3 and Vth4. Time t3 during which the charge and discharge signal X decreases from the level of the reference voltage Vth4 to reach the level of the reference voltage Vth3 is expressed by the following equation:
t3=CO×(Vth4−Vth3)/(I2−I1),
where the interval time period t_int and the watch time period t_watch are given by the following equations (5) and (6).

$$\begin{matrix}\begin{matrix}t\_int = t 1 + t 2 \\ = C 0 \times ( Vth 2 - Vth 1 ) / ( I 1 / I 2 \times ( I 2 - I 1 ) )\end{matrix} & ( 5 ) \\ \begin{matrix}t\_watch = t 3 \\ = C 0 \times ( Vth 4 - Vth 3 ) / ( I 2 - I 1 )\end{matrix} & ( 6 )\end{matrix}$$

Thus, the ratio of time constant, i.e., the ratio between the interval time period t_int and the watch time period t_watch, is found by the following equation (7).
t_int/t_watch =((Vth4−Vth3)/(Vth2−Vth1))×(I1/I2) (7)

The ratio of the time constant is set based on (i) the ratio of the currents (I1/I2) and (ii) the ratio of voltage differences ((Vth4−Vth3)/(Vth2−Vth1)).

Table 2 below shows examples of set values required to satisfy the following conditions: t_int=1 sec (=1000msec) and t_watch=1 msec.

TABLE 2

| T_int | T_watch | C | | Vth2 − Vth1 | Vth4 − Vth3 | I1 | | I2 | |
|---|---|---|---|---|---|---|---|---|---|
| 1 sec | 1 msec | 0.1 | uF | 1 V | 0.1 V | 100 | nA | 10 | uA |
| | | 0.01 | uF | | | 10 | nA | 1 | uA |
| | | 0.001 | uF | | | 1 | nA | 0.1 | uA |

It becomes possible to set a difference in time constant t_int:t_watch=1000:1 based on voltage differences (Vth4−Vth3):Vth2−Vth1) and a current difference I1:I2, separately. The conventional arrangement described above requires to set II:I2=1: 1000. In the present embodiment, however, it is possible to set I1:I2=1:100 by setting Vth4−Vth3=0.1V. This makes it possible to obtain a large ratio of the time constant without increasing a consumption current of an oscillator circuit, compared to a ratio obtained in the conventional example.

By setting a start time period of the receiving device 3 to be longer than the watch time period t_watch, it becomes possible to drive the receiving device 3 which receives an input signal via infrared communication to perform a periodical intermittent operation. Examples of the receiving device performing infrared communication include IrDA (Infrared Data Association) devices, infrared remote controllers, and the like. In IrDA devices, commonly, a start time period (i.e., SD (shutdown) recovery time) of the receiving device 3 is several hundred μsec orders. In infrared remote controllers, a start time period is several hundred msec. By setting the watch time period t_watch longer than the start time period of the receiving device 3, it is ensured that the receiving device 3 operates reliably when receiving an input signal during the watch time period t_watch.

In the present embodiment, the current ratio I1:I2 can be reduced by using a voltage difference (reference voltage Vth4−reference voltage Vth3). The current ratio I1:I2 can be further reduced by reducing the voltage difference (reference voltage Vth4−reference voltage Vth3). However, if the voltage difference (reference voltage Vth4−reference voltage Vth3) is made further small, the circuit malfunctions when Vth4>Vth3 is not satisfied, due to process variations and/or other factors. The following factors are considered as causes of such malfunction:

(1) Variations in reference voltages Vth3 and Vth4

(2) Input offset voltage of a comparator circuit

Regarding (1), Vth4>Vth3 is ensured by configuring the reference voltages Vth1 through Vth4 using the resistors as shown in FIG. 5.

Regarding (2), one reason for applying the input offset voltage is mismatching in characteristics of MOS transistor elements in a differential input stage. The following (a) and (b) are considered as causes of such mismatching in characteristics of MOS transistors:

(a) Tilt angle for implanting an ion to a source and a drain (tilt angle ion implantation)

Generally, in processing a MOS transistor, since ion implantation is performed with an angle, the source and the drain are not formed in symmetric. By arranging MOS transistor elements in common-centroid layout (symmetric with respect to a dot) as shown in FIG. 4, the MOS transistor elements are evenly affected by ion implantation performed with any angle. This reduces mismatching of the MOS transistor elements.

(b) Influence of gradient of parameters in in-plane MOS transistor elements

Since parameters of in-plane elements have gradients, mismatching in characteristics may occur between elements horizontally adjacent to each other and/or elements vertically adjacent to each other. Examples of the parameters include a channel impurity concentration nch and a channel threshold voltage vt0. As shown in FIG. 4, with the common-centroid layout (symmetric with respect to a point), even when parameters have gradients, MOS transistors in a differential input stage are evenly affected by the gradients. This reduces mismatching in characteristics of MOS transistor elements.

[Second Embodiment]

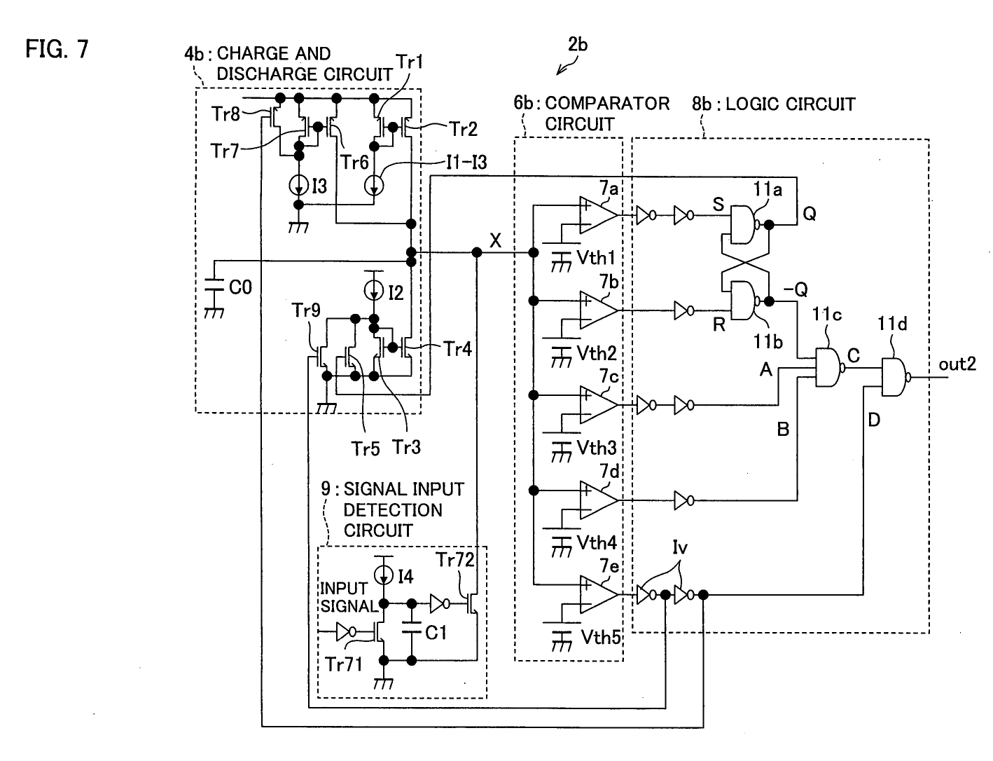

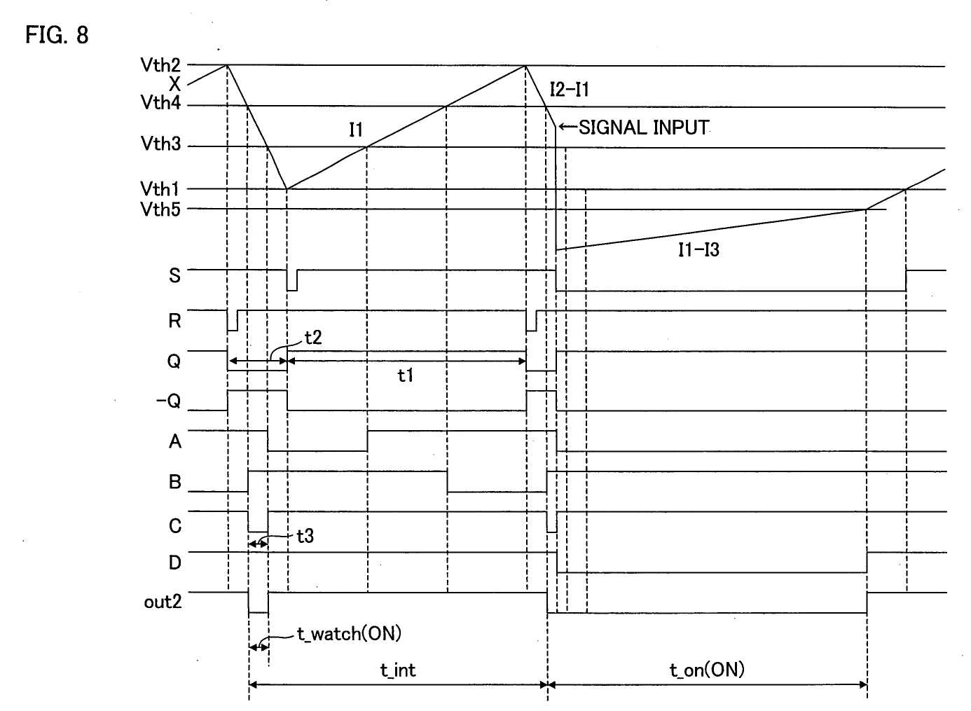

FIG. 7 is a circuit diagram illustrating substantial parts of an oscillator circuit 2b according to a second embodiment. FIG. 8 is a waveform chart representing operations of the oscillator circuit 2b. Constituting elements being the same as those described in the first embodiment are indicated by the same reference numerals, and their detailed explanations are omitted.

The oscillator circuit 2b includes a charge and discharge circuit 4b. The charge and discharge circuit 4b includes a PMOS Tr1 having a drain connected to one end of a current source (I1−I3). Another end of the current source (I1−I3) is connected to ground. The charge and discharge circuit 4b further includes PMOS Tr6 and Tr7, whose gates and sources are respectively connected to each other. The gate and a drain of the PMOS Tr7 are connected to each other, and the drain of the PMOS Tr7 is connected to one end of a current source I3. Another end of the current source I3 is connected to ground. The source and the drain of Tr7 are connected to a source and a drain of Tr8, respectively, and the sources of the PMOS Tr6 and Tr7 are connected to the source of Tr8. A drain of the PMOS Tr6 is connected to a capacitor CO. The charge and discharge circuit 4b further includes an NMOS Tr9 and an NMOS Tr3, whose sources and drains are respectively connected to each other.

The oscillator circuit 2b includes a signal input detection circuit 9. The signal input detection circuit 9 includes an NMOS Tr71 having: a gate which receives an input signal through an inverter; a source connected to a current source I4; and a drain connected to ground. The signal input detection circuit 9 further includes a capacitor C1. One terminal of the capacitor C1 is connected to the source of the NMOS Tr71, and another terminal of the NMOS Tr71 is connected to the drain of the NMOS Tr71. The signal input detection circuit 9 further includes an NMOS Tr72 having: a gate connected to the source of the NMOS Tr71 through an inverter; a drain connected to the drain of the NMOS Tr71; and a source connected to a line through which a charge and discharge signal X is supplied to a comparator circuit 6b.

The comparator circuit 6b includes a comparator 7e which compares (i) the charge and discharge signal X and (ii) a reference voltage Vth5. The oscillator circuit 2b further includes a logic circuit 8b having a NAND circuit 11d. One input terminal of the NAND circuit 11d receives a signal C from a NAND circuit 11c. Another input terminal of the NAND circuit 11d receives a signal D, which is derived from a signal outputted from the comparator 7e and inverted through two inverters Iv. An output signal of the preceding inverter Iv is supplied to a gate of the NMOS Tr9, and an output signal of the subsequent inverter Iv is supplied to a gate of the PMOS Tr8. Further, an output signal out2 is outputted from the NAND circuit 11d.

When the charge and discharge signal X decreases from the level of a reference voltage Vth2 and reaches the level of a reference voltage Vth4, an output signal of a comparator 7d is inverted from high to low, and accordingly a signal B is inverted from low to high. This causes all signals -Q, A, and B to be supplied to an NAND element 11c in a high state. As a result, the signal C outputted from the NAND element 11c is inverted from high to low. Since the signal D is in a high state, the output signal out2 of the NAND circuit 11d is inverted from high to low.

In a case where the charge and discharge signal X further decreases from the level of the reference voltage Vth4 toward the level of a reference voltage Vth3, if a signal is supplied to the signal input detection circuit 9 before the charge and discharge signal X reaches the level of the reference voltage Vth3, the charge and discharge signal X suddenly decreases to a voltage level below the reference voltage Vth5. This causes the output signal of the comparator 7e to be inverted from high to low, and the output signal of the preceding inverter Iv to be inverted from low to high, with the result that the N-channel MOS Tr9 is turned ON. Accordingly, the output signal of the subsequent inverter IV is inverted from high to low, causing the P-channel MOS Tr8 to be turned ON. As a result, discharging of a capacitor CO by a current (I2−I1) is stopped, and the capacitor CO is charged by a current (I1−I3).

A signal S derived from an output signal of a comparator 7a is inverted from high to low. Accordingly, a signal Q is inverted from low to high, and the signal -Q is inverted from high to low. The signal A derived from the output signal of a comparator 7c is inverted from high to low, and accordingly the signal C outputted from the NAND circuit 11c is inverted from low to high. Since the signal D derived from the output signal of the comparator 7e is inverted from high to low, the output signal out2 of the NAND circuit 11d is maintained low.

Further, when the charge and discharge signal X increases and reaches the level of the reference voltage Vth5, the output signal of the comparator 7e is inverted from low to high, and the output signal of the preceding inverter is inverted from high to low, with the result that the N-channel MOS Tr9 is turned OFF. Further, the output signal of the subsequent inverter is inverted from low to high, causing the P-channel MOS Tr8 to be turned OFF. As a result, discharging of the capacitor CO by the current (I1−I3) is stopped, and the capacitor CO is charged by a current I1. The signal D derived from the output signal of the comparator 7e is inverted from low to high, causing the output signal out2 of the NAND circuit 11d to be inverted from low to high.

When the charge and discharge X increases from the level of the reference voltage Vth5 and reaches the level of a reference voltage Vth1, the signal S derived from the output signal of the comparator 7a is inverted from low to high. This causes the charge and discharge signal X to increase from the level of the reference voltage Vth1 to the level of the reference voltage Vth3.

As such, the reference voltage Vth5 is supplied to the comparator 7e. Based on the reference voltage Vth5, a hold time period is set during which the receiving device 3 is maintained in an ON state according to an externally supplied signal.

When a signal is externally supplied in a time period during which the periodical intermittent operation of a receiving device 3 is in an ON state (watch time period t_watch (ON)), the receiving device 3 needs to be maintained in an ON state so as to satisfy the following relationship, according to the second embodiment.
t_on=CO×Vth5/(I1−I3)

Note that, the foregoing describes the case where the reference voltage Vth5 is lower than the reference voltage Vth1. However, the present invention is not limited to this. The reference voltage Vth5 may be set higher than the reference voltage Vth2. Further, the foregoing describes the arrangement in which, based on the reference voltage Vth5, the receiving device 3 is maintained in an ON state in response to an externally supplied signal. However, the present invention is not limited to this, and the receiving device 3 may be maintained in an OFF state.

[Third Embodiment]

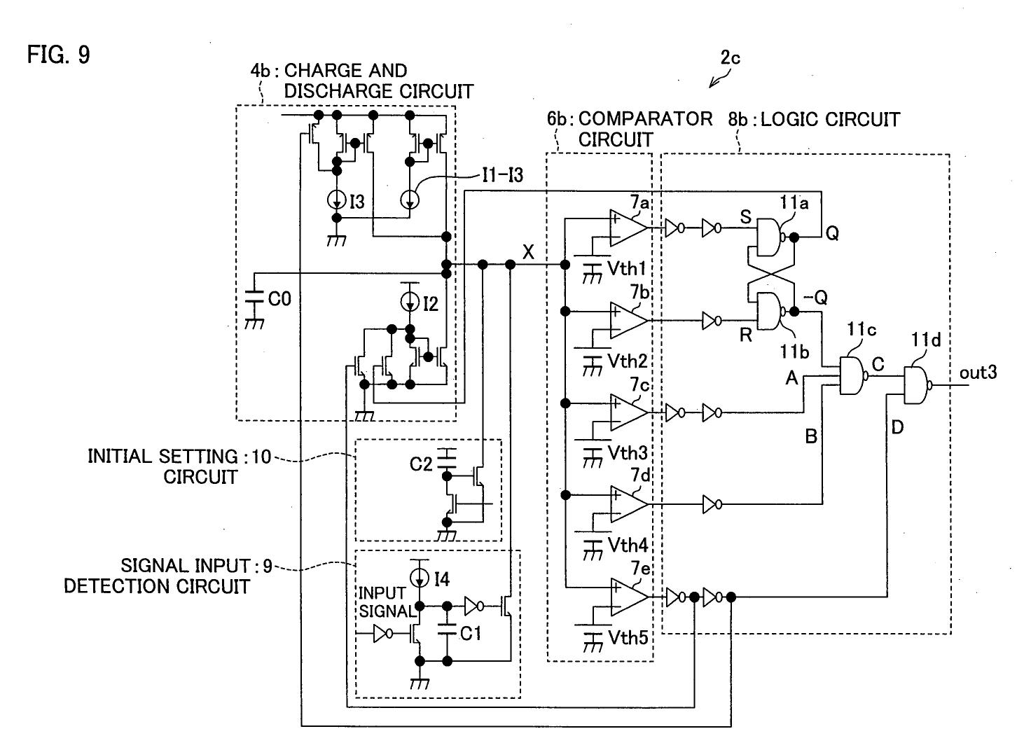

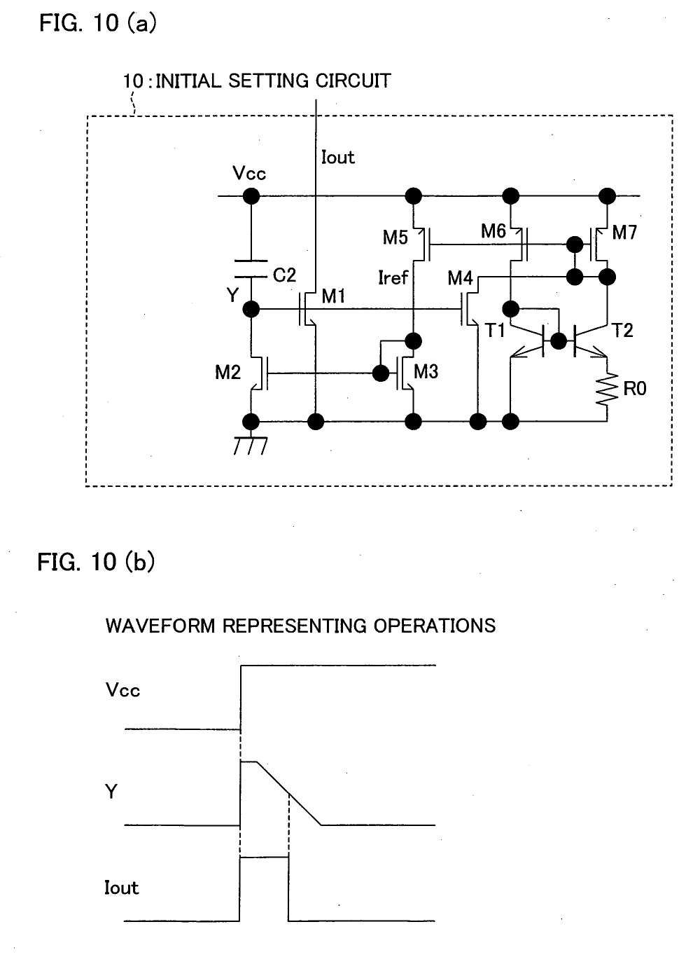

FIG. 9 is a circuit diagram illustrating substantial parts of an oscillator circuit 2c according to a third embodiment. FIG. 10(a) is a circuit diagram illustrating a circuitry of an initial setting circuit 10 provided in the oscillator circuit 2c, and FIG. 10(b) is a waveform chart representing its operations. Constituting elements being the same as those described in the second embodiment are indicated by the same reference numerals, and their detailed explanations are omitted.

The initial setting circuit 10 includes NMOS transistors M2 and M3, whose gates are connected to each other. The NMOS transistor M2 has a source connected to one terminal of a capacitor C2 through a terminal Y. Another terminal of the capacitor C2 is connected to a line through which a power supply voltage Vcc is supplied. The gate and a source of the NMOS transistor M3 are connected to each other. The initial setting circuit 10 further includes NMOS transistors M1 and M4, whose gates are connected to each other. The gate of the NMOS transistor M1 is connected to the terminal Y, and a source of the NMOS transistor M1 is connected to a line through which a charge and discharge signal X is supplied to a comparator circuit 6b. The initial setting circuit 10 further includes PMOS transistors M5, M6, and M7, whose gates are connected to each other. The PMOS transistor M5 has a drain which outputs a current Iref to the source and the gate of the NMOS transistor M3. The gate and a drain of the PMOS transistor M7 are connected to each other, both connected to a source of the NMOS transistor M4. Sources of the PMOS transistors M5, M6, and M7 are connected to the line through which the power supply voltage Vcc is supplied. The initial setting circuit 10 further includes NMOS transistors T1 and T2, whose gates are connected to each other. The gate and a source of the NMOS transistor T1 are connected to each other, and the source of the NMOS transistor T1 is connected to a drain of the PMOS transistor M6. A source of the NMOS transistor T2 is connected to the drain of the PMOS transistor M7, and a drain of the NMOS transistor T2 is connected to ground through a resistor R0. Drains of the NMOS transistors T1, M4, M3, and M2 are connected to the ground.

When the power is turned ON, a voltage at the terminal Y is charged by the capacitor C2 and increased to the level of the power supply voltage Vcc. A constant current source then start operating, the capacitor C2 is discharged by the constant current source, and the voltage at the terminal Y decreases to a ground level. As such, the current Iout, supplied to the source of the NMOS transistor M1, flows from a charge and discharge circuit 4b to the initial setting circuit 10 only when the power supply voltage Vcc is supplied.

Thus, when the power is turned ON, the current Iout flows from the charge and discharge circuit 4b to the initial setting circuit 10, and an initial voltage of the charge and discharge signal X becomes lower than the reference voltage Vth5. The capacitor CO is then charged by the current (I1−I3). When the charge and discharge signal X increases and reaches the level of the reference voltage Vth5, an output signal of a comparator 7e is inverted from low to high, and accordingly an output signal of the preceding inverter is inverted from high to low, with the result that the N-channel MOS Tr9 is turned OFF. Further, an output signal of the subsequent inverter is inverted from low to high, causing the P-channel MOS Tr8 to be turned OFF. As a result, discharging of the capacitor CO by the current (I1−I3) is stopped, and the capacitor CO is charged by the current I1. Accordingly, a signal D derived from the output signal of the comparator 7e is inverted from low to high, and an output signal out3 of an NAND circuit 11d is inverted from low to high.

In an oscillator circuit, there may be a case where the state of the circuit becomes unstable depending on an initial condition of the circuit when the power is turned ON. For example, when a receiving device starts oscillation in an OFF state (during a time period other than the watch time period) when the power is turned ON, the receiving device is activated after a lapse of the interval time period t_int at the maximum. According to the third embodiment, the initial setting circuit 10 is provided which has a function for initial setting when the power is turned ON. The initial setting circuit 10 causes the oscillator circuit to stably operate when the power is turned ON. This enables the charge and discharge circuit 2c to start operating when an output signal out3 is in a low state and when the receiving device is in an ON state (during a time period t_on (ON)). Accordingly, the oscillator circuit 2d can start operating when the receiving device in the ON state. Thus, the oscillator circuit 2d stably operates when it is activated.

[Fourth Embodiment]

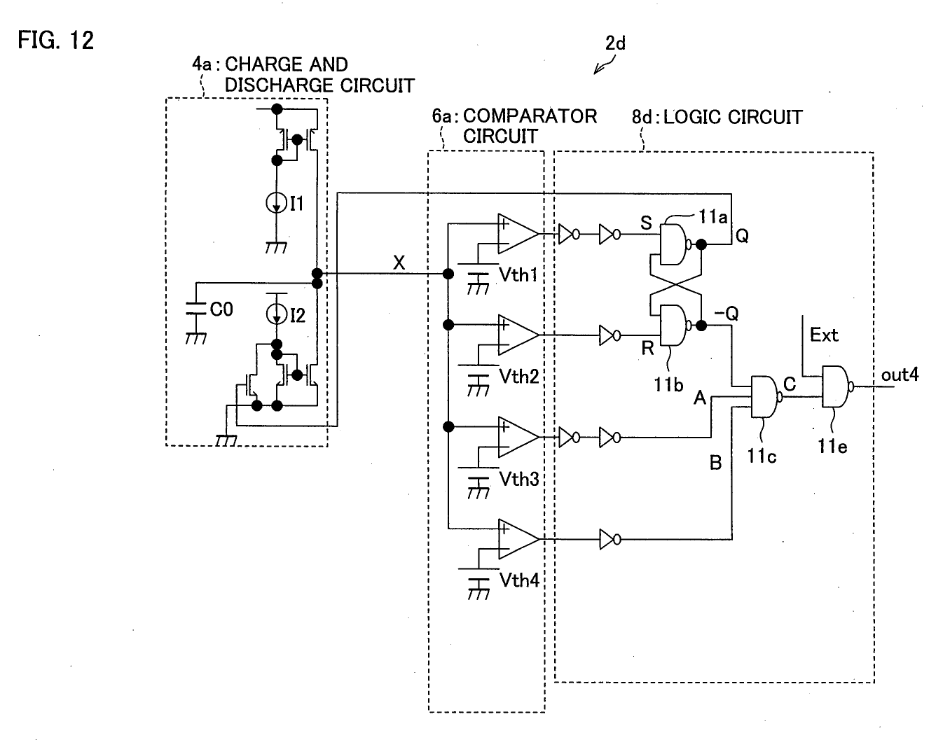

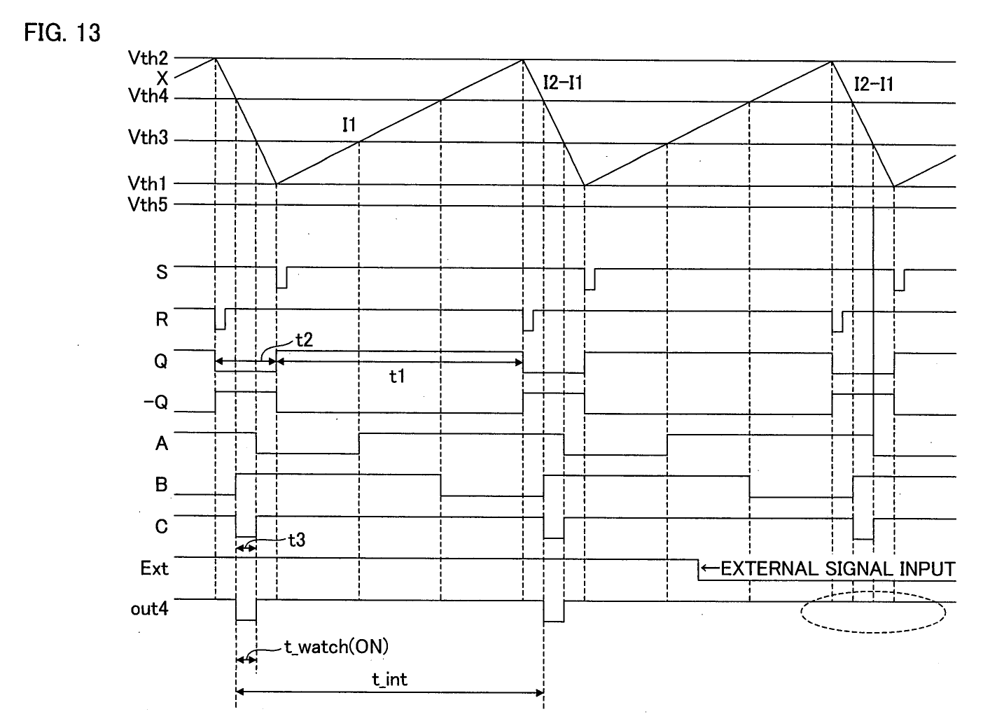

FIG. 12 is a circuit diagram illustrating substantial parts of an oscillator circuit 2d according to a fourth embodiment. FIG. 13 is a waveform chart representing operations of the oscillator circuit 2d. Constituting elements being the same as those described in the first embodiment are indicated by the same reference numerals, and their detailed explanations are omitted.

The oscillator circuit 2d includes a logic circuit 8d. The logic circuit 8d includes a logic element 11e. The logic element 11e outputs an output signal out4 based on (i) an externally supplied signal ext and (ii) a signal C outputted from an AND circuit 11c.

When a capacitor CO is charged by a current source I1, and a charge and discharge signal X rises from the level of a reference voltage Vth1. Then, when the charge and discharge signal X reaches the level of a reference voltage Vth3, an output signal of a comparator 7c is inverted from low to high, and accordingly a signal A is inverted from low to high. When the charge and discharge signal X further increases from the level of the reference voltage Vth3 and reaches the level of a reference voltage Vth4, an output signal of a comparator 7d is inverted from low to high, and accordingly a signal B is inverted from high to low. When the charge and discharge signal X further increases from the level of the reference voltage Vth4 and reaches the level of a reference voltage Vth2, an output signal of a comparator 7b is inverted from low to high, and accordingly a signal R is inverted from high to low. This causes an output signal -Q of a NAND element 11b to be inverted from low to high, and an output signal Q of a NAND element 11a to be inverted from high to low. As a result, a Tr5 of a charge and discharge circuit 4a is turned OFF, and a current source I2 starts discharging the capacitor CO. Since the current source I1 constantly charges the capacitor CO, the capacitor CO is discharged by a current expressed by ((current of the current source I2)−(current of the current source I1)) when (current of the current source I2)>(current of the current source I1) is set. This causes the charge and discharge signal X to start decreasing from the level of the reference voltage Vth2, and the signal R to be inverted from low to high.

When the charge and discharge signal X decreases from the level of the reference voltage Vth2 and reaches the level of the reference voltage Vth4, the output signal of the comparator 7d is inverted from high to low, and accordingly the signal B is inverted from low to high. This causes all the signals -Q, A, and B to be supplied to an NAND element 11c in a high state. As a result, the signal C outputted from the NAND element 11c is inverted from low to high, causing the output signal out4 of the logic circuit 8d to be inverted from high to low.

When the charge and discharge signal X decreases from the level of the reference voltage Vth4 and reaches the level of the reference voltage Vth3, the output signal of the comparator 7c is inverted from high to low, and accordingly the signal A is inverted from high to low. Since one of the signals -Q, A, and B, i.e., signal A, is inverted from high to low, the signal C outputted from the NAND element 11c is inverted again from high to low, with the result that the output signal out4 is inverted again from low to high.

When the charge and discharge signal X further decreases from the level of the reference voltage Vth3 and reaches the level of a reference voltage Vth1, an output signal out2 of a comparator 7a is inverted from high to low, and accordingly a signal S is inverted from high to low, causing the signal Q from the NAND element 11a to be inverted from low to high. As a result, the Tr5 is turned ON, and the current source I2 stops discharging the capacitor CO. The capacitor CO is then charged again by the current source I1, and the charge and discharge signal X rises again from the level of the reference voltage Vth1 to the level of reference voltage Vth3.

When the externally supplied signal Ext is inverted from high to low while the charge and discharge signal X rises from the level of the reference voltage Vth1, exceeds the level of the reference voltage Vth3, and further increases toward the level of the reference voltage Vth4, the output signal out4 is maintained high. Further, when the charge and discharge signal X reaches the level of the reference voltage Vth2 and is inverted, and then decrease to the level of the reference voltage Vth4, the signal B is inverted from low to high and the signal C is inverted from high to low. Since the externally supplied signal Ext is maintained low, the output signal out4 of the logic element 11e is maintained high.

As such, by controlling the logic circuit 8d according to the externally supplied signal Ext, the state of the receiving device can be switched from the state of the periodical intermittent operation to an ON state compulsorily.

The present invention is not limited to the description of the embodiments above, but may be altered by a skilled person within the scope of the claims. An embodiment based on a proper combination of technical means disclosed in different embodiments is encompassed in the technical scope of the present invention.

The present invention is applied to oscillator circuits and infrared receivers which drive a receiving device to perform a periodical intermittent operation.

It is preferable in the oscillator circuit of the present embodiment that the first voltage be lower than the second voltage, and that the signal generating circuit set, in the signal based on a fifth voltage, a hold time period indicative of a time period during which a state of the receiving device is maintained in response to an externally supplied signal, the fifth voltage falling outside the range between the first and second voltages.

According to the arrangement, when a signal is externally supplied while the periodical intermittent operation of the receiving device is in an ON state, the ON state can be maintained. Further, when a signal is externally supplied while the periodical intermittent operation of the receiving device is in an OFF state, the OFF state can be maintained. The fifth voltage may be lower than the first voltage or higher than the second voltage.

It is preferable in the oscillator circuit of the present embodiment that the signal generating circuit set, in the signal based on the fifth signal, an initial hold time period causing the oscillator circuit to stably operate when a power supply voltage is supplied.

According to the arrangement, the oscillator circuit stably operates when the power supply voltage is supplied.

It is preferable in the oscillator circuit of the present embodiment that the signal generating circuit include: a comparator circuit for comparing the charge and discharge signal with the first voltage, the second voltage, the third voltage, and the fourth voltage, respectively; and a logic circuit which sets in the signal the interval time period and the watch time period, based on results of comparisons made by the comparator circuit.

According to the arrangement, it becomes easy to configure the oscillator circuit as an integrated circuit.

It is preferable in the oscillator circuit of the present embodiment that the logic circuit set, in the signal in response to an externally supplied signal, a time period during which a state of the receiving device is maintained compulsorily.

According to the arrangement, the state of the receiving device can be set in the ON or OFF state compulsorily.

It is preferable in the oscillator circuit of the present embodiment that the signal generating circuit set the watch time period to be longer than a start time period of the receiving device.

According to the arrangement, the watch time period is longer than the start time period of the receiving device. This ensures that the receiving device operates reliably when the receiving device receives a signal during the watch time period.

It is preferable in the oscillator circuit of the present embodiment that at least two of the first to fourth voltages be generated by a plurality of resistors provided in series.

According to the arrangement, the reference voltages are affected by process variations less likely. Further, it is ensured that the two reference voltages have a certain relationship in voltage values.

It is preferable in the oscillator circuit of the present embodiment that transistors provided in an input stage of each of the comparator circuits be arranged in a common-centroid layout.

According to the arrangement, it is possible to reduce an input offset voltage of the comparator circuit.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An oscillator circuit, comprising:
a charge and discharge circuit for charging or discharging a capacitor; and
a signal generating circuit for generating a signal in which (i) an interval time period indicative of a cycle on which cycle a receiving device performs a periodical intermittent operation and (ii) a watch time period indicative of a time period during which the receiving device performing the intermittent operation is in an ON state are set based on a charge and discharge signal which varies according to charging and discharging of said charge and discharge circuit with respect to the capacitor,
said signal generating circuit setting in the signal (i) the interval time period based on a difference between first and second voltages and (ii) the watch time period based on a difference between third and fourth voltages, the third and fourth voltages falling in a range between the first and second voltages.

2. The oscillator circuit according to claim 1, wherein:
the first voltage is lower than the second voltage, and
said signal generating circuit sets, in the signal based on a fifth voltage, a hold time period indicative of a time period during which a state of the receiving device is maintained in response to an externally supplied signal, the fifth voltage falling outside the range between the first and second voltages.

3. The oscillator circuit according to claim 2, wherein said signal generating circuit sets, in the signal based on the fifth signal, an initial hold time period causing the oscillator circuit to stably operate when a power supply voltage is supplied.

4. The oscillator circuit according to claim 1, wherein said signal generating circuit includes:
a comparator circuit for comparing the charge and discharge signal with the first voltage, the second voltage, the third voltage, and the fourth voltage, respectively; and
a logic circuit which sets in the signal the interval time period and the watch time period, based on results of comparisons made by the comparator circuit.

5. The oscillator circuit according to claim 4, wherein the logic circuit sets, in the signal in response to an externally supplied signal, a time period during which a state of the receiving device is maintained compulsorily.

6. The oscillator circuit according to claim 1, wherein said signal generating circuit sets the watch time period to be longer than a start time period of the receiving device.

7. The oscillator circuit according to claim 4, wherein at least two of the first to fourth voltages are generated by a plurality of resistors provided in series.

8. The oscillator circuit according to claim 4, wherein transistors provided in an input stage of each of the comparator circuits are arranged in a common-centroid layout.

9. An infrared receiver, comprising:
an oscillator circuit recited in claim 1; and
a receiving device which performs the periodical intermittent operation based on the signal generated by the oscillator circuit.
